(19) United States
(12) Patent Application Publication
(10) Pub. No.: US 2013/0297257 A1
(43) Pub. Date: Nov. 7, 2013

(54) Energy Separation System, Method, and Program Product for Detecting Faulty Bearings

(71) Applicant: Jun Yang, Richmond, VA (US)

(72) Inventor: Jun Yang, Richmond, VA (US)

(21) Appl. No.: 13/464,867

(22) Filed: May 4, 2012

(51) Int. Cl. G06F 15/00; G01N 29/14

(52) U.S. Cl. 702/183

(57) ABSTRACT

A faulty bearing detection system provides means and methods for detecting a fault associated with a bearing. The fault detection system includes a vehicle with bearings and a computerized system to separate multiple vibrations from, chiefly the shaft, to identify the amount of faults in the bearings. The system converts mechanical information to electrical information, filters periodic signals for removal, filters background noise, and performs an energy ratio calculation for determining a potential fault condition and communicates the status of a bearing fault condition. By separating the bearing faulty impulse signals from the raw vibration signals, the bearing faulty signal-to-noise ratio is improved. Furthermore, by calculating the energy ratio between the bearing faulty signals and the periodic vibration signals, the loading effects added to the traditional bearing features are removed.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fault detection. More particularly, one or more embodiments of the invention relate to a computerized method for detecting faulty bearings.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Bearings are components in many rotating machines and the degradation of bearings over time is one of the reasons that cause a machine to breakdown. Therefore, effective methods for monitoring the degradation process of the bearings and to make an earlier prediction of a failure prior to the failure occurring can be cost-effective in reducing operational costs.

Among the methods for bearing diagnostics and prognostics, vibration-based techniques are widely used since it is easy to obtain vibration signals and a significant amount of information is contained in the vibration signals.

A fault detection system will be described which provides means and methods for detecting a fault associated with a bearing. The system converts mechanical information to electrical information, filters periodic signals for removal, filters background noise for removal, performs a ratio calculation for determining a potential fault condition and communicates the status of a bearing fault condition.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of an example fault detection system, in accordance with an embodiment of the present invention;

FIG. 2 is a block diagram of an example fault detection portion described with reference to FIG. 1, in accordance with an embodiment of the present invention;

FIG. 3 illustrates an example method for the fault detection system as described with reference to FIGS. 1-2, in accordance with an embodiment of the present invention; and

FIG. 4 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A fault detection system will be described which provides means and methods for detecting a fault associated with a bearing. The system converts mechanical information to electrical information, filters periodic signals for removal, performs a ratio calculation for determining a potential fault condition and communicates the status of a bearing fault condition.

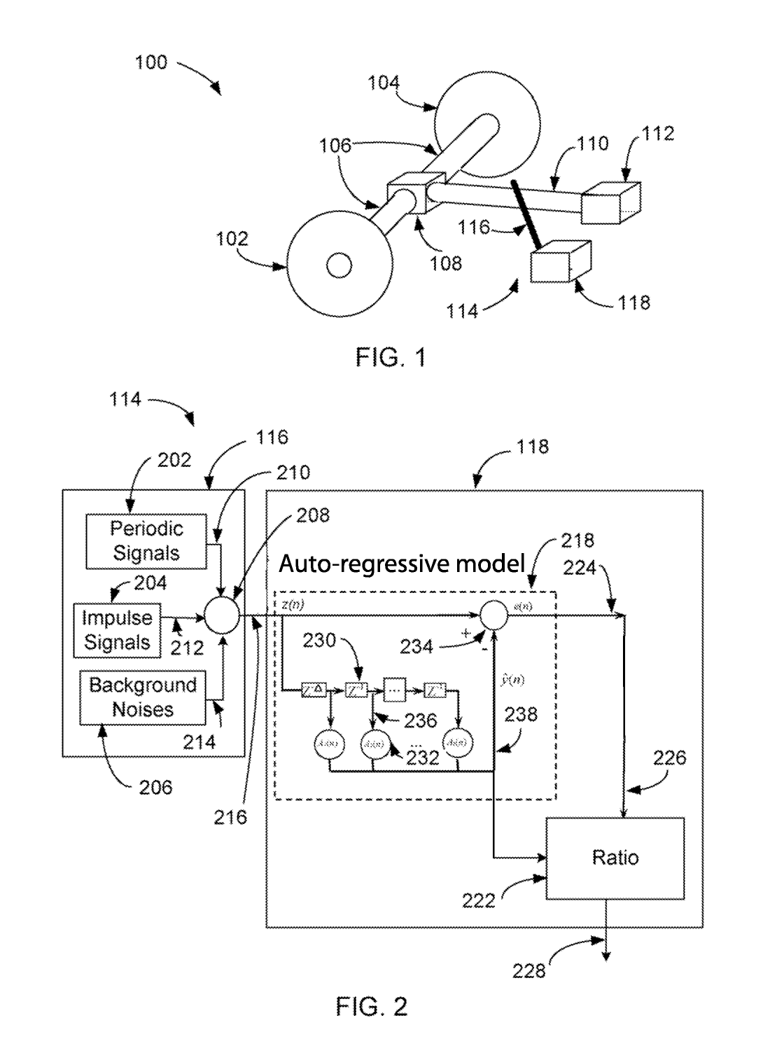

The system will now be described in detail with reference to FIGS. 1-4.

FIG. 1 is a diagram of an example fault detection system, in accordance with an embodiment of the present invention.

A fault detection system 100 includes a pair of wheels 104, an axle 106, a transmission 108, a shaft 110, a motor 112 and a fault detection portion 114.

Motor 112 provides mechanical power to shaft 110. Shaft 110 provides mechanical power to transmission 108. Transmission 108 transfers mechanical power from shaft 110 to axle 106. Axle 106 transfers mechanical power to pair of wheels 104. Pair of wheels 104, axle 106, transmission 108, shaft 110 and motor 112 include bearings (not shown) for providing transmission of mechanical power.

Fault detection portion 114 receives and processes information for determining bearing fault failures.

Fault detection portion 114 includes a transducer portion 116 and a processing portion 118.

Transducer portion 116 converts mechanical information into electrical information. Processing portion 118 receives and processes information for determining failures associated with a bearing fault. Non-limiting examples for processing portion 118 include personal computers, industrial computers, micro-chip based control units, portable devices operating via any known operating system.

In operation, motor 112 provides mechanical power to shaft 110, shaft provides mechanical power to transmission 108, transmission 108 transfers mechanical power from shaft 110 to axle 106, axle 106 transfers mechanical power to pair of wheels 104. Pair of wheels 104 transfers mechanical power to the ground (not shown). Furthermore, transducer portion 116 receives and converts mechanical information to electrical information and communicated electrical information to processing portion 118. Processing portion 118 receives and processes electrical information for determining a failure associated with a bearing fault.

FIG. 1 is a diagram of an example fault detection system for detecting failures associated with a bearing fault.

Operation of processing portion 118 will be further described with reference to FIG. 2.

FIG. 2 is a block diagram of an example fault detection portion described with reference to FIG. 1, in accordance with an embodiment of the present invention.

Fault detection portion 114 includes transducer portion 116 and processing portion 118.

Transducer portion 116 includes a periodic signals portion 202, an impulse signals portion 204, a background noises portion 206 and a summation portion 208.

Periodic signals portion 202 represents periodic signals received by transducer portion 116. Impulse signals portion 204 represents signals generated by a faulty bearing and received by transducer portion 116. Background noises portion 206 represents background noise received by transducer portion 116. Summation portion 208 represents a model for summing received inputs and providing a summation of the received inputs.

Summation portion 208 receives periodic signal information from periodic signals portion 202 through a periodic vibration signal 210 and receives impulse signal information from impulse signals portion 204 through an impulse signal 212 and receives background noise from background noises portion 206 through a background noise signal 214.

In operation, transducer portion 116 receives periodic signals from periodic signals portion 202, receives impulse signals from impulse signals portion 204, receives background noise from background noises portion 206 and performs a summing operation of the received signals and provides the summation of the received signals through a summation communication channel 216.

Processing portion 118 includes a filter portion 218, and a ratio calculation portion 222.

Filter portion 218 provides, receives, and processes a received signal through summation communication channel 216 to provide a filtered signal. As a non limiting example, filter portion 218 may be configured as an Auto Regressive model.

Ratio calculation portion 222 provides capability to perform a ratio calculation.

Filter portion 218 receives information from summation portion 208 through summation communication channel 216 Ratio calculation portion 222 receives information from a threshold de-noising portion (optional step, not shown) through a de-noising communication channel 226, receives information from summation portion 208 through summation communication channel 216 and provides information through a ratio communication channel 228.

The information communicated through summation communication channel 216 represents the information communicated through summation communication channel 216 with the information associated with periodic signals portion 202 removed. The information communicated the de-noising communication channel 226 represents the information communicated through de-noising communication channel 216 with the information associated with periodic signals portion 202 removed. Furthermore and alternatively, the information communicated through de-noising communication channel 226 also represents the information associated with impulse signals portion 204, as the information associated with periodic signals portion 202 is removed through filter portion 218.

Filter portion 218 includes a multiplicity of delay elements with a sampling noted as a delay element 230, a multiplicity of multiplication elements with a sampling noted as a multiplication element 232 and a subtraction portion 234.

Delay element 230 provides capability to delay information. Multiplication element 232 provides capability to perform a multiplication operation. Subtraction portion 234 provides capability to perform a subtraction operation.

Multiplication element 232 receives information from delay element 230 through delay communication channel 236. Subtraction portion 234 receives information from summation portion 208 through summation communication channel 216 and receives a summation of information from the outputs of the multiplication elements through multiplication communication channel 238.

Subtraction portion 234 subtracts the information received through multiplication communication channel 238 from the information received through summation communication channel 216 and provides the result of the subtraction to subtraction communication channel 224.

In operation, transducer portion 116 receives mechanical information including information associated with periodic vibration signals 210, impulse signals 212, and background noise signal 214. Transducer portion 116 converts the mechanical information to electrical information and communicates the information to processing portion 118. Processing portion 118 receives the information from transducer portion 116 and performs a filtering operation through filter portion 218 to remove periodic vibration signals 210. Ratio calculation portion 222 performs a ratio operation to determine if a bearing fault has occurred and provide information through ratio communication channel 228 with an indication as to whether a bearing fault condition has been detected or has not been detected.

An autoregressive model (AR) is applied to separate the original vibration signal of the bearing into the random parts and the deterministic parts and then the energy ratio between the random parts and the original signal is calculated as the fault indicator.

As a non-limiting example, the vibration signal collected from a shaft transmission system with bearing fault includes the deterministic periodic vibration signal 210, due to the imbalance and misalignment of the shaft 110 and the random components. As a non-limiting example, the random components include the impulses generated by the fault bearing, and the random noise. It can be expressed by Equation (1) shown below:

Sₖ=(gₖ+nₖ+dₖ)*hₖ (1)

In Equation (1), gₖ represents the fault impulse as illustrated by impulse signals portion 204, nₖ represents the noise as illustrated by background noises portion 206, dₖ represents the periodic portion as illustrated by periodic signals portion 202 and hₖ represents the transmission path effect associated with transmission of the signals and noise through elements of fault detection system 100 such as transducer portion 116, shaft 110, transmission 108, axel 106, and pair of wheels 104.

When a bearing fault develops, the energy of the random portions increase but the periodic vibration signal 210, which in one embodiment is generated mainly by the shaft 110, remains the same since the fault associated with the bearing does not affect the imbalance and misalignment of the shaft 110. So the energy ratio between the random components and the original signal increases. This property allows the energy ratio to indicate the damage level of the tested bearing. Furthermore, when the loading added to the bearing housing (not shown) varies, the amplitudes of the periodic portions and the random portions change in the same direction. This property makes this type of indicator robust with respect to the variations associated with the loading. The AR model is used to remove the periodic part of the vibration signal. As a non-limiting example, the AR model residual signal includes the random portions of the signal. For a bearing remaining in a healthy condition, AR residual signal represents the random prediction error of the AR model.

The use of the model as a one-step-ahead predictor is described through Equation (2) as shown below:

$${\hat{s}}_{k} = {\sum }_{i = 1}^{p} {a}_{i} {s}_{i - k} + {ɛ}_{k} \qquad ( 2 )$$

Where p represents the order of the model, aᵢ for i=1, 2, . . . , p represents weighting coefficients, sₖ represents the k^{th} data point, ŝₖ represents the data point predicted by the AR filter and εₖ represents the prediction error for the data point. The εₖ contains the stationary noise and the impulses generated by the faulty bearing.

The periodic vibration signals are filtered by an AR filter (e.g., without limitation, delay element 230, multiplication element 232, etc.) and the residual signal is obtained by subtracting the filtered portion from the original signal. Background noise is then filtered through a threshold de-noising portion 220. Then the energy ratio between the residual signal and the original signal is calculated. The energy ratio is used as the condition indicator of the rolling element bearing. The energy of a discrete signal series (s) of length N is defined by Equation (3) as shown below:

$$E = {\sum }_{i = 1}^{N} {s}_{i}^{2} \qquad ( 3 )$$

Where, sᵢ represents the discrete signal series consisting of N elements.

The energy ratio is defined as Equation (4) as shown below:

$${R}_{E} = \frac{{\sum }_{i = 1}^{N} {ɛ}_{i}^{2}}{{\sum }_{i = 1}^{N} {Y}_{kt}^{2}} \qquad ( 4 )$$

Where, Yₜ represents the periodic portions of the discrete signal consisting of N elements and εₜ is the random parts of the discrete signal consisting of N elements. Please replace Yₖₜ with Yₜ. [PLEASE YOU NEED TO MAKE THAT CHANGE].

By separating the bearing faulty impulse signals from the raw vibration signals, the bearing faulty signal-to-noise ratio is improved. Furthermore, by calculating the energy ratio between the bearing faulty signals and the periodic vibration signals, the loading effects added to the traditional bearing features are removed.

FIG. 2 is a block diagram of an example fault detection portion described with reference to FIG. 1 where mechanical information is converted to electrical information and filtered to remove periodic signals and background noise then processed for determining whether a fault condition associated with a bearing has occurred.

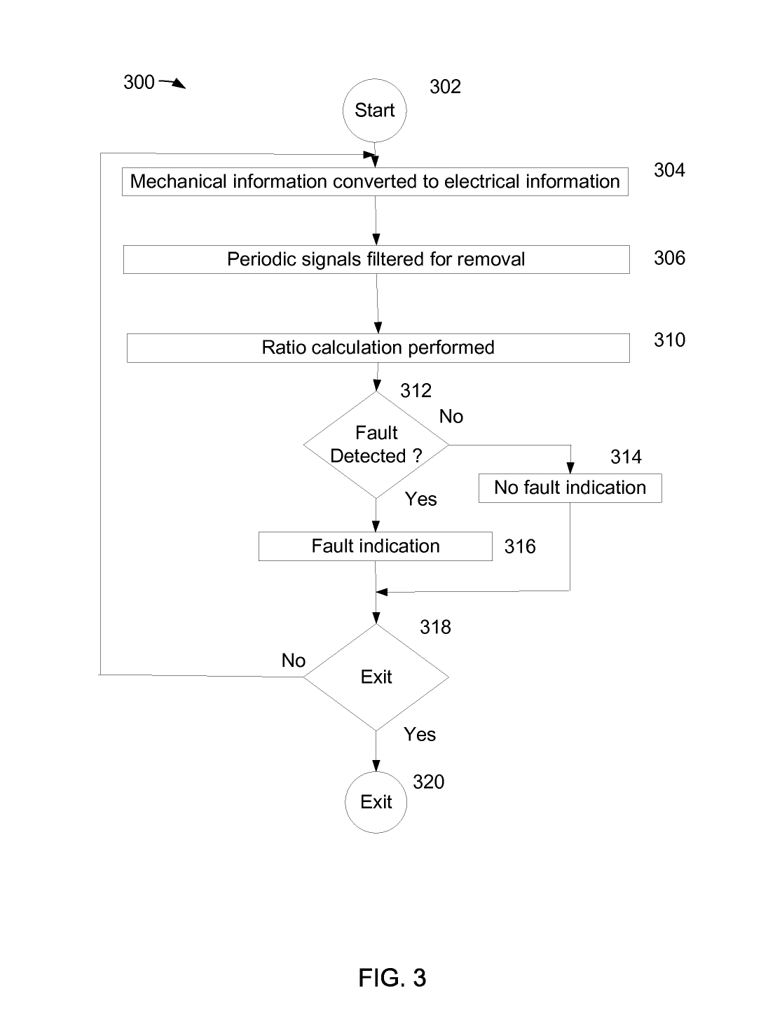

A computerized method for detecting faulty bearings 300 as described with reference to FIGS. 1-2 will now be described with reference to FIG. 3.

FIG. 3 illustrates an exemplary computerized method for detecting faulty bearings 300 as described with reference to FIGS. 1-2, in accordance with an embodiment of the present invention.

Referring to FIG. 3, a computerized method for detecting faulty bearings 300 initiates in a step 302, providing the fault detection system 100. In one embodiment, the fault detection system may include a vehicle with bearings and a computerized system to separate multiple vibrations from chiefly the shaft to identify the amount of faults in the bearings.

Then in a step 304, detecting the periodic vibration signal from the faulty bearing.

Similarly, a step 306 requires detecting the impulse signal from the faulty bearing.

A step 308 includes detecting the background noise signal from the faulty bearing.

As a non-limiting example, mechanical information is received from shaft 110 (FIG. 1) through transducer portion 116 (FIGS. 1-2), and step 310 results, converting the periodic vibration signal to an electrical signal with the transducer portion through summation communication channel 216 (FIG. 2).

As shown in FIG. 3, a step 312 requires converting impulse signal to an electrical signal with transducer portion through summation communication channel 216 (FIG. 2).

As a non-limiting example, mechanical information is received from shaft 110 (FIG. 1) through transducer portion 116 (FIGS. 1-2), and step 314 results, converting background noise signal to an electrical signal with transducer portion through summation communication channel 216 (FIG. 2).

Prior to leaving transducer portion 116, step 316 requires summing periodic vibration signal 210, and impulse signal 212, and background noise signal 214.

In processing portion 118, step 318 involves separating periodic vibration signal 210 from impulse signal 212. As a non-limiting example, filter portion 218 (FIG. 2) removes periodic vibration signals 210.

A step 320 includes delaying periodic vibration signal 210 in filter portion 218. Next, the multiplying periodic vibration signal 210 is multiplied in filter portion 218 in step 322.

As shown in FIG. 3, a step 324 involves subtracting said periodic vibration signal from said impulse signal. Those skilled in the art can appreciate that by separating the bearing faulty impulse signals from the raw vibration signals, the bearing faulty signal-to-noise ratio is typically improved.

As shown in FIG. 3, a step 326 involves filtering background noise from signal with threshold de-noising portion 220.

As shown in FIG. 3, a step 328 involves separating impulse signal from periodic vibration signal. The separation allows for ratio calculations for determining faulty bearings. This may be expressed in Equation (3).

Finally, step 330 involves calculating an energy ratio. It is contemplated that the energy ratio may include impulse signal 212 over periodic vibration signal 210. The energy ratio signal is calculated through ratio calculation portion 222 (FIG. 2) using Equation (4).

Referring back to FIG. 3, in a step 332 a determination is performed for exiting method for detecting faulty bearings 300. From the energy ratio, step 332 allows for determining for a fault detection associated with the bearings. After determining whether a faulty bearing exists, it is then possible to exit the system, or loop back to step 302 to test for faulty bearings again. In one embodiment, as a non-limiting example, ratio calculation portion 222 (FIG. 2) does not detect a fault condition and communicates a condition of no fault through communication channel 228 (FIG. 2).

A fault detection system 100 and a method for determining faulty bearings 300 have been presented. The system and method provide bearing health degradation information.

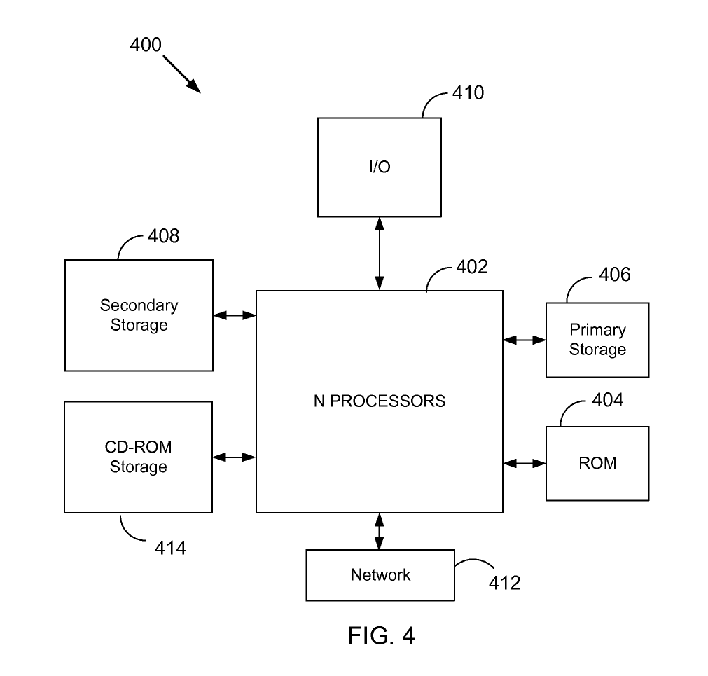

FIG. 4 illustrates a typical computer system that, when appropriately configured or designed, may serve as a computer system 400 for which the present invention may be embodied.

Computer system 400 includes a quantity of processors 402 (also referred to as central processing units, or CPUs) that may be coupled to storage devices including a first primary storage 406 (typically a random access memory, or RAM), a second primary storage 404 (typically a read-only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, second primary storage 404 acts to transfer data and instructions uni-directionally to the CPU and first primary storage 406 typically may be used to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and typically may be used as a secondary storage medium such as a hard disk. It will be appreciated that the information retained within mass storage device 408, may, in appropriate cases, be incorporated in standard fashion as part of first primary storage 406 as virtual memory. A specific mass storage device 408 such as a CD-ROM 414 may also pass data uni-directionally to the CPU 402.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU 402 might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of fault detection according to the present invention will be apparent to those skilled in the art. The invention has been described above by way of illustration, and the specific embodiments disclosed are not intended to limit the invention to the particular forms disclosed. For example, the particular implementation of the transducer may vary depending upon the particular type mechanical device used. The mechanical devices described in the foregoing were directed to metal-based implementations; however, similar techniques using non-metal (e.g. plastic) implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method for detecting a faulty bearing comprising the steps of:
(a) converting at least one mechanical energy to at least one electrical signal;
(b) filtering said an electrical signal;
(c) calculating a bearing fault feature, said calculation being at least in part based on an energy ratio between an impulsive signal and a periodic signal; and
(d) at least in part based on said bearing fault feature, deciding if said faulty bearings exist.

2. The method of claim 1, in which said step (a) further comprises detecting a periodic vibration signal from said faulty bearing.

3. The method of claim 2, in which said step (a) further comprises detecting an impulse signal from said faulty bearing.

4. The method of claim 3, in which said step (a) further comprises detecting a background noise signal from said faulty bearing.

5. The method of claim 4, in which said step (a) further comprises converting said periodic vibration signal to said electrical signal.

6. The method of claim 5, in which said step (a) further comprises converting said impulse signal to said electrical signal.

7. The method of claim 6, in which said step (a) further comprises converting said background noise signal to said electrical signal.

8. The method of claim 7, in which said step (b) further comprises summing said periodic vibration signal, and said impulse signal, and said background noise signal.

9. The method of claim 8, in which said step (b) further comprises separating said periodic vibration signal from said impulse signal, said separation being achieved at least in part based on an auto-regressive model.

10. The method of claim 9, in which said step (b) further comprises delaying said periodic vibration signal.

11. The method of claim 10, in which said step (b) further comprises multiplying said periodic vibration signal.

12. The method of claim 11, in which said step (b) further comprises subtracting said periodic vibration signal from said impulse signal.

13. The method of claim 12, in which said step (b) further comprises filtering said background noise signal with said threshold de-noising portion.

14. The method of claim 13, in which said step (b) further comprises separating said impulse signal from said periodic vibration signal.

15. The method of claim 14, in which said step (c) further comprises calculating said ratio between said impulse signal and said periodic vibration signal.

16. The method of claim 1, wherein said step (b) separates said periodic vibration signal from said impulse signal for calculating said ratio.

17. A system for detecting faulty bearings comprising:
means for converting at least one mechanical energy to at least one electrical signal;
means for filtering said at least one electrical signal;
means for calculating a ratio; and
means for deciding if said faulty bearings exist.

18. A computer program product comprising:
(a) computer code for detecting a periodic vibration signal from a faulty bearing;
(b) computer code for detecting an impulse signal from said faulty bearing;
(c) computer code for detecting a background noise signal from said faulty bearing;
(d) computer code for converting said periodic vibration signal to an electrical signal;
(e) computer code for converting said impulse signal to said electrical signal;
(f) computer code for converting said background noise signal to said electrical signal;
(g) computer code for summing said periodic vibration signal, and summing impulse signal, and said background noise signal;
(h) computer code for separating said periodic vibration signal from said impulse signal;
(i) computer code for delaying said periodic vibration signal;
(j) computer code for multiplying said periodic vibration signal;
(k) computer code for subtracting said periodic vibration signal from said impulse signal;
(l) computer code for filtering said background noise signal;
(m) computer code for separating said impulse signal from said periodic vibration signal;
(n) computer code for calculating a ratio; and
(o) computer code for deciding if said faulty bearing exists.
